(19) United States
(12) Patent Application Publication
(10) Pub. No.: US 2011/0098370 A1
(43) Pub. Date: Apr. 28, 2011

(54) SULFONATED POLY 2-(PHENYL ETHYL) SILOXANE POLYMER ELECTROLYTE MEMBRANES

(75) Inventors: E. Bradley Easton, Oshawa (CA); Amanda Northcotf, Oshawa (CA)

(73) Assignee: University of Ontario Institute of Technology, Oshawa, Ontario, ON (CA)

(21) Appl. No.: 12/994,232

(22) PCT Filed: May 25, 2009
(86) PCT No.: PCT/CA2009/000739

§ 371 Date: Jan. 11, 2011

Related U.S. Application Data
(60) Provisional application No. 61/071,910, filed on May 23, 2008.

(51) Int. Cl. B01J 39/18

(52) U.S. Cl. 521/27

(57) ABSTRACT

The present invention provides polymer electrolyte membranes (PEM) based upon sulfonated poly 2-(phenyl ethyl)siloxane (SPPES) prepared in a one-pot procedure. This includes the SPPES homopolymer as well as random copolymer of SPPES with various non-sulfonated polysiloxanes. Copolymerization with poly 2-(phenyl ethyl)siloxane greatly improves the mechanical stability of the film compared to a SPPES homopolymer. Proton conductivity of the copolymer, though it is less than that of the homopolymer and Nafion, is comparable to other PEMs in the literature. Both SPPES based membranes show good water retention at temperature greater than 100° C., which indicates they may be suitable for use in high temperature PEM fuel cells.

### CROSS REFERENCE TO RELATED U.S. PATENT APPLICATION

This patent application relates to, and claims priority from, U.S. Provisional Patent Application Ser. No. 61/071,910 filed on May 23, 2008 entitled SULFONATED POLY 2-(PHENYL ETHYL)SILOXANE POLYMER ELECTROLYTE MEMBRANES, filed in English, which is incorporated herein in its entirety by reference.

### FIELD OF THE INVENTION

The present invention relates to polymer electrolyte membranes (PEM) based upon sulfonated poly 2-(phenyl ethyl)siloxane (SPPES).

### BACKGROUND OF THE INVENTION

Sol-gels are a broad class of materials in which a solid phase is formed through the gellation of a colloidal suspension (sol). Metal alkoxide precursors are common since they react under mild conditions with water. Of those, silicon-based precursors are the most popular. One particularly interesting area of sol-gel research is the development of “inorganic-organic hybrid” materials. These are formed from hydrolyzable monomers that contain an organic moiety (R), which is covalently attached via a Si—C bond. The mild conditions of the sol-gel reaction allow organic and biological molecules to survive the glass formation process, as opposed to conventional inorganic glasses that require high temperature melting. The resulting siloxane polymers, often referred to as Ormosils or Ormocers (organically modified silicates/ceramics), have a surface coated with organic functional groups that greatly influence the properties of the materials (e.g. permselectivity, hydrophobicity) [1;2]. The materials are particularly promising for electrochemical applications [3] [4;5] [6].

Silicate-based materials have recently been reported for use in polymer electrolyte membrane fuel cells (PEMFC). Perfluorosulfonic acid ionomers, PFSI, are presently the most widely employed polymer electrolyte membrane (PEM) in fuel cells, with Nafion® being the most common. However, PFSI electrolytes remain expensive and have several limiting factors such as high methanol permeability, degradation under relatively dry conditions, and dramatic decrease in conductivity at low relative humidity, therefore 80° C. is their maximum application temperature [7]. Because of these limitations, there is a great desire to discover alternative PEMs. Primary requirements for these new materials are high proton conductivity, good thermochemical stability, and mechanical strength.

Silicate-based materials have been investigated as an alternative proton conducting medium for fuel cells, both as a membranes as well as serving as the ion conductor within the electrodes. Easton and co-workers reported the surface modification of a fuel electrocatalyst with a sulfonated silane [8]. A fuel cell electrode prepared with their modified catalyst containing only 10 wt % Nafion was shown to achieve similar fuel cell performance as an un-modified catalyst with a 30 wt % Nafion loading. Anderson et al., have also reported the use of SiO₂ within the electrocatalyst layer for direct methanol fuel cells [9]. This kind of electrode structure is referred to as a carbon ceramic electrode [1].

Sol-gel derived Nafion/Silica composite membranes are promising for high temperature applications [10;11] [12]. Studies have shown that these membranes have good ionic conductivity at temperatures greater than 100° C. due to higher water retention [13;14]. In spite of this, there have been very few reports of sol-gel derived inorganic-organic hybrid PEMs (i.e. non-composites of similar chemistry). Gautier-Luneau and co-workers [15] reported a poly(benzylsulfonic acid)siloxane copolymer that displayed high proton conductivity and thermal stability up to 250° C. Most recent reports of other inorganic-organic hybrid membranes concern either composite membranes (e.g. Nafion/Silica composites) or require heteropolyacid (HPA) dopants to become proton conductive [16-20].

### SUMMARY OF THE INVENTION

To address the problems described above, the present invention relates to the synthesis and characterization of polymer electrolyte membranes based upon a sulfonated poly 2-(phenyl ethyl)siloxane (SPPES) and a non-sulfonated organosilane precursor, as represented by:

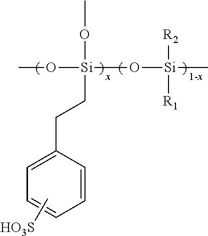

where 0≦X≦1 and X represents the relative proportion of SPPES; R₁ and R₂ are substituent groups on said non-sulfonated organosilane precursor. Some non-limiting examples of non-sulfonated organosilane precursors are shown in FIG. 1.

The membranes may be formed in a one-pot procedure as follows: (1) a mixture is prepared comprised of 2-phenylethyl-triethoxysilane and anhydrous dichloromethane; (2) the mixture is sulfonated via addition of a sulfonating agent, such as but not limited to ClSO₃H or (CH₃)₃SiSO₃Cl, and stirred for a period of time to ensure completion of the reaction; (3) a non-sulfonated organosilane monomer is added; (4) said mixture is copolymerized via addition of methanol or ethanol, deionized water, and either acid or base to catalyze the reaction, and refluxed for a period of time to ensure substantial completion of the reaction; (5) the mixture allowed to evaporate; as shown in FIG. 2.

The above-mentioned procedure can also be carried out by using 2-phenyiethyl-trimethoxysilane or 2-phenylethyl-trichlorosilane as the organosilane monomer in the step (1), instead of 2-phenylethyl-triethoxysilane.

In an alternative embodiment of the present invention, the above-mentioned procedure can also be carried out by using pre-sulfonated monomer in step a), without a separate sulfonation step. In this alternative embodiment, the pre-sulfonated monomer may be one of 2-(4-chlorosulfonylphenyl)ethyltrimethoxy silane, 2-(4-chlorosulfonylphenyl)ethyltriethoxy silane and 2-(4-chlorosulfonylphenyl)ethyltrichloro silane.

The present invention describes one-pot membrane synthesis that yields flexible polymer films, suitable for numerous applications without polymer post-processing. This process is simple and robust such that different SPPES-copolymers can be prepared by varying the amounts of different non-sulfonated organosilane monomers. Since these materials are cation exchange membranes, target applications for these materials include (but are not limited to) PEM fuel cells, direct methanol fuel cells, lithium ion batteries, water purification, gas separators, and the chloro-alkali process.

An embodiment of the present invention provides a method of synthesis of sulfonated poly 2-(phenyl ethyl)siloxane membranes. The method involves steps of: a) preparing a mixture comprised of any one of 2-phenylethyl-triethoxysilane, 2-phenylethyl-trimethoxysilane and 2-phenylethyl-trichlorosilane as an organosilanemonomer and anhydrous dichloromethane; b) sulfonating said mixture and stirring for a period of time to ensure substantial completion of the reaction; c) adding a non-sulfonated organosilane monomer to said sulfonated mixture; d) copolymerizing said sulfonated mixture to which said non-sulfonated organosilane monomer has been added by addition of an alcohol, deionized water, and either acid or base to catalyze the reaction, and refluxed for a period of time to ensure substantial completion of the reaction; and e) evaporating solvents and isolating a sulfonated poly 2-(phenyl ethyl)siloxane copolymer membrane.

Another embodiment of the present invention provides a method of synthesis of sulfonated poly 2-(phenyl ethyl)siloxane membranes comprising the steps of: a) preparing a mixture comprised of any one of 2-(4-chlorosulfonylphenyl)ethyltrimethoxy silane, 2-(4-chlorosulfonylphenyl)ethyltriethoxy silane and 2-(4-chlorosulfonylphenyl)ethyltrichioro silane as a pre-sulfonated organosilane monomer, and anhydrous dichloromethane; b) adding a non-sulfonated organosilane monomer to said sulfonated mixture; c) copolymerizing said sulfonated monomer to which said non-sulfonated organosilane monomer has been added by addition of an alcohol, deionized water, and either acid or base to catalyze the reaction, and refluxed for a period of time to ensure substantial completion of the reaction; and d) evaporating solvents and isolating a sulfonated poly 2-(phenyl ethyl)siloxane copolymer membrane.

A further understanding of the functional and advantageous aspects of the invention can be realized by reference to the following detailed description and drawings.

### BRIEF DESCRIPTION OF THE DRAWINGS

Embodiments of the present invention are described in greater detail with reference to the accompanying drawings, in which:

FIG. 1 is list of examples of non-sulfonated organosilane precursors;

FIG. 2 is a reaction scheme for the synthesis of copolymers of sulfonated poly 2-(phenyl ethyl)siloxane (SPPES) and non-sulfonated organosilane precursor;

FIG. 3 is a photograph of SPPES(100) membrane (“100” denotes 100% sulfonation). The film has a diameter of 10 cm and a thickness of 141 μm;

FIG. 4 is a photograph of the conductivity cell (a) open and (b) assembled and connected to the impedance analyzer;

FIG. 5 is a graph of (a) TGA curves and (b) differential thermograms (DTG) obtained for the SPPES(100) and SPPES(40) membranes (“40” denotes 40% sulfonation). Samples were heated from room temperature to 1000° C. at a heating rate of 15° C./min under flowing Argon; and

FIG. 6 is a graph of membrane resistances as a function of thickness for SPPES membranes. Also shown are the membrane resistances obtained for Nafion membranes as well as literature data for two SPEEK (Sulfonated Poly(ether ether ketone)) membranes [22]. Measurements were made at room temperature using fully hydrated membranes.

### DETAILED DESCRIPTION OF THE INVENTION

Generally speaking, the invention described herein is directed to synthesis of polymer electrolyte membranes based upon sulfonated poly 2-(phenyl ethyl)siloxane (SPPES). As required, embodiments of the present invention are disclosed herein. However, the disclosed embodiments are merely exemplary, and it should be understood that the method may be embodied in many various and alternative forms. The figures are not to scale and some features may be exaggerated or minimized to show details of particular elements while related elements may have been eliminated to prevent obscuring novel aspects. Therefore, specific structural and functional details disclosed herein are not to be interpreted as limiting but merely as a basis for the claims and as a representative basis for teaching one skilled in the art to variously employ the present invention. For purposes of teaching and not limitation, the illustrated embodiments are directed to the synthesis of polymer electrolyte membranes based upon a sulfonated poly 2-(phenyl ethyl)siloxane (SPPES) homopolymer (X=1.00) as well as a SPPES/poly 2-(phenyl ethyl)siloxane copolymer (X=0.40).

As used herein, the terms “about” and “ca.”, when used in conjunction with ranges of dimensions of particles, reaction temperatures, reactant concentrations, reaction times, or any other physical or chemical properties or characteristics, are meant to cover slight variations that may exist in the upper and lower limits of the ranges of dimensions so as to not exclude embodiments where on average most of the dimensions are satisfied but where statistically dimensions may exist outside this region. It is not the intention to exclude embodiments such as these from the present invention.

The present invention relates to the synthesis and characterization of polymer electrolyte membranes based upon a sulfonated poly 2-(phenyl ethyl)siloxane (SPPES) and a non-sulfonated organosilane precursor, as represented by:

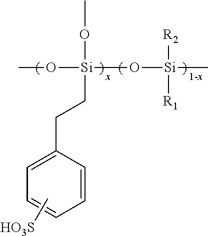

where 0≦X≦1 and X represents the relative proportion of SPPES, R₁ and R₂ are substituent groups on said non-sulfonated organosilane precursor. Some exemplary, non-limiting examples of non-sulfonated organosilane precursors are shown in FIG. 1.

A number of embodiments of the present invention are possible for differing applications. The following description is illustrative of one embodiment and is not meant to be limiting.

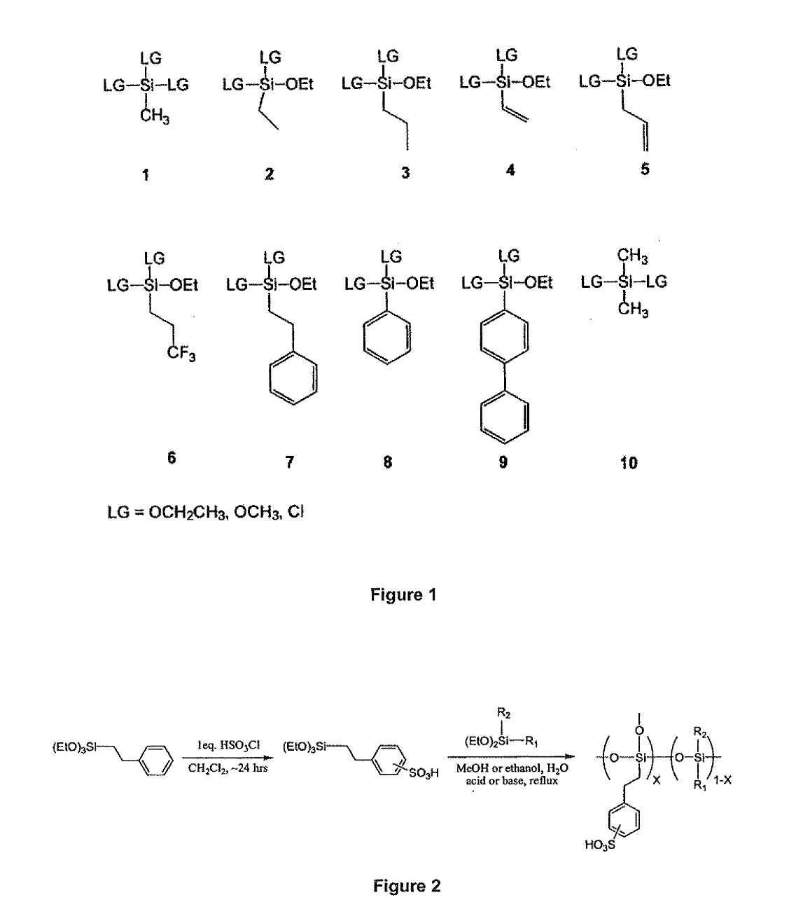

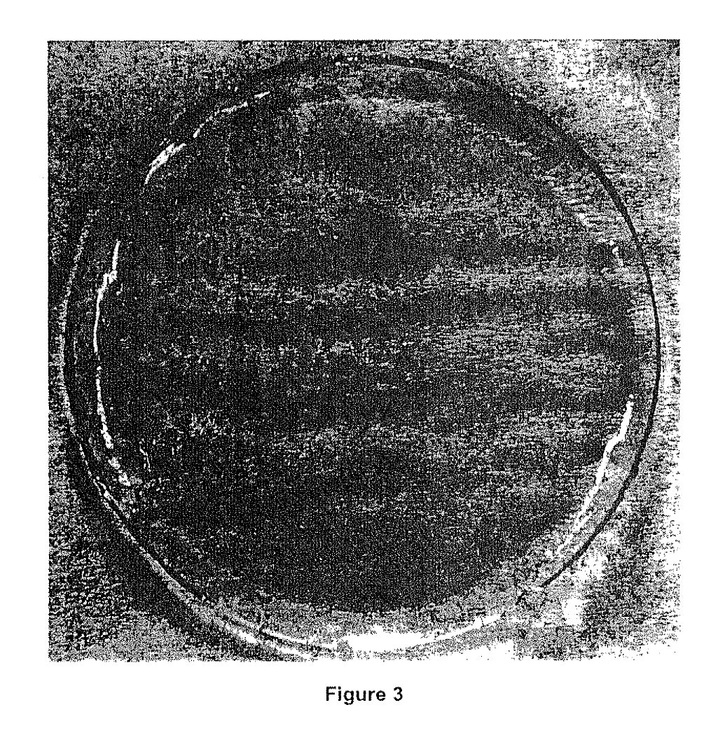

Copolymers of sulfonated poly 2-(phenyl ethyl)siloxane (SPPES)/poly 2-(phenyl ethyl)siloxane (PPES) were prepared via a one-pot procedure, as shown in FIG. 2. Those skilled in the art will appreciate that FIG. 2 shows an exemplary synthesis and it will be appreciated that the various reagents, acids, bases, sulfonating agents shown are exemplary, non-limiting examples. Polymers were prepared as either a 100% SPPES homopolymer (X=1.00) or as a 40% SPPES/60% PPES copolymer (X=0.40). Polymers are reported herein as SPPES (%), where % represents X stated as a percentage. X is also referred to as the polymers degree of sulfonation (DS). It should be noted that the entire range 0≦X≦1 is feasible and that the membrane properties heavily depend on this value.

1 mL of 2-phenylethyl-triethoxysilane (Gelest) was combined with 6 mL anhydrous dichloromethane (Sigma-Aldrich) in a septum capped 3-neck round bottom flask under nitrogen at room temperature to give a 10% silane solution. Sulfonation of the phenyl ring was performed by the drop wise addition of a stoichiometric amount (0.3 mL) of ClSO₃H via a syringe (but it will be appreciated that (CH₃)₃SiSO₃Cl may also be used). The solution was stirred at room temperature for ca. 24 hours to ensure the sulfonation reaction was complete. At this point, value of X can be controlled by varying the amount of non-sulfonated organosilane added in this step. In this example, another 1.5 mL of 2-phenylethyl-triethoxysilane (the non-sulfonated organosilane) was added to form the copolymer with X=0.40; for the homopolymer (X=1.00) no 2-phenylethyl-triethoxysilane was added. The polymerization reaction was performed by adding 25 mL methanol (ACS grade, Fisher), 0.24 mL deionized water and 2 drops (˜0.1 mL) concentrated HCl. The reaction mixture was then refluxed for 6 hours.

After ca. 1 hour the solution color changed from colorless to light brown and remained this color throughout the rest of the reaction. The solution was subsequently allowed to cool. Polymer films were formed by pouring the solution into a shallow Teflon evaporating dish (10 cm diameter) and then allowing the solvent to evaporate over the course of 14 days. The surface of the resultant film was washed with ethanol to remove any un-reacted monomers, after which the film was removed from the Teflon dish and stored in deionized water for 24 hours prior use. A photographs of the SPPES (100) membrane is shown in FIG. 2.

Membrane thicknesses were determined with a micrometer and are an average of at least three measurements at different points within the film. The thickness of SPPES(100) and SPPES(40) membranes were determined to be 141 μm and 85 μm, respectively.

Thermogravimetric Analysis (TGA) and differential scanning calorimetry was performed simultaneously using a TA Instruments Q600 SDT thermal analyzer. Samples (ca. 10 mg) were heated from room temperature up to 1000° C. at a rate of 15° C./min under flowing argon. Since these samples absorb water at room temperature, the mass at 200° C. was defined as the dry mass and used at 100% value all TGA data presented here. This process has been previously used and verified by other work in our lab [21].

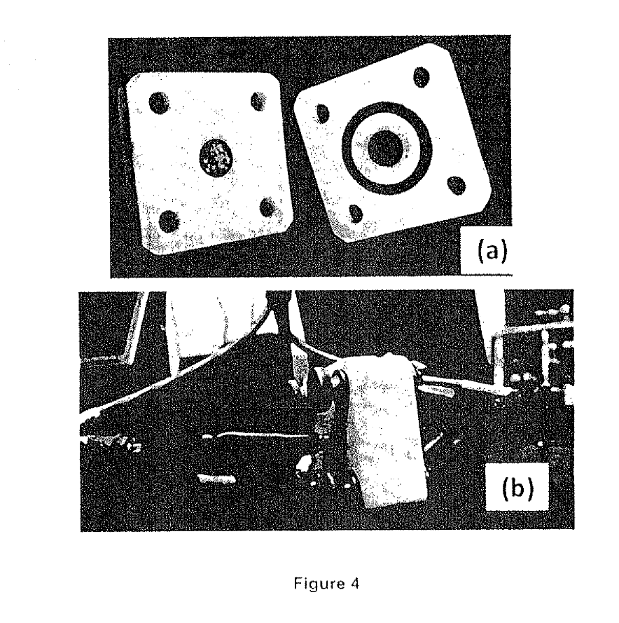

Proton conductivity was measured by electrochemical impedance spectroscopy (EIS) using a sandwich cell at room temperature. A photograph of the sandwich cell is shown in FIG. 4. Measurements were performed on the acidic form of the membranes, which were stored in deionized water for 24 hours prior to use. Membranes were removed from water and patted dry with a Kimwipe to removed excess surface water. The membrane was subsequently sandwiched between two 1-cm² Pt black electrodes and placed between the Teflon blocks so that the electrodes are aligned with the electrical contacts. Impedance spectra between 40 kHz and 500 Hz were obtained under ambient conditions using a sandwich cell. The uncompensated resistance, R_{UC}, was determined from the high frequency intercept of a Nyquist plot, and can be expressed as:

$${R}_{UC} = {R}_{mem} + {R}_{cell} = \frac{d}{σ} + {R}_{cell} \qquad ( 1 )$$

where Rₘₑₘ, d, and σ are the ionic resistance, thickness and conductivity of the membrane, respectively. R_{cell} is the cell resistance, which has contributions from the electrodes and the cell contacts. R_{cell} was evaluated by measuring the conductivity of Nafion membranes of varying thickness and was determined to be 0.035 Ωcm². The conductivity of Nafion was determined to be 0.069 S/cm, which agrees very well with values reported in the literature [22].

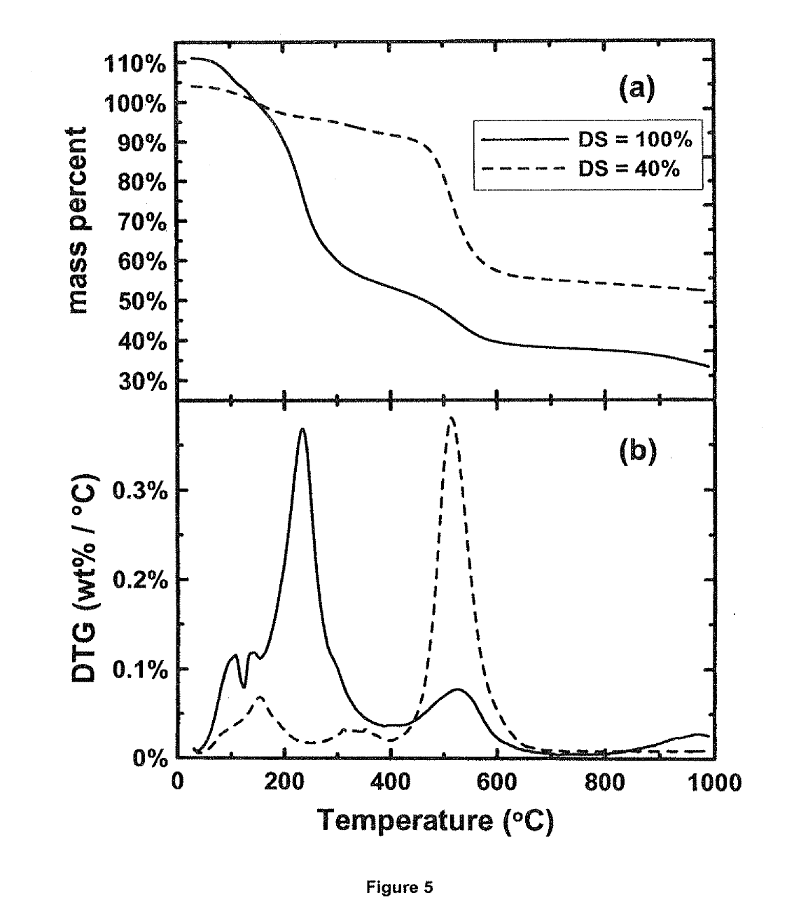

FIG. 5 shows the TGA curves obtained for SPPES(100) and SPPES(40). Both membranes show a mass loss between 60-200° C. due to the loss of water from the films. From this we see that SPPES(100) absorbed significantly more water than SPPES(40), as expected since the water content has been shown to be related to DS in other PEMs [23]. it is worth noting in these curves that a significant amount of water is retained in these films above 100° C., much more than that observed for Nafion (not shown). Based upon this, we would expect SPPES-based membranes to undergo a significantly smaller decrease in proton conductivity at higher temperatures than Nafion-based PEMS, and therefore could be more suitable for higher temperature fuel cell operation.

As the temperature is increased above 200° C., decomposition of the sulfonic acid groups in the polymer occurs, with SPPES(100) exhibiting a greater mass loss. Above 400° C., the ethyl phenyl side chain of both polymers decomposed to give a carbonaceous residue and SiO₂.

The room temperature membrane resistance and proton conductivity of each SPPES membrane is listed in Table 1 (fully hydrated and at 25° C.).

TABLE 1

| Membrane | d (μm) | Rₘₑₘ (Ω cm²) | σ (S/cm) |
|---|---|---|---|
| SPPES(100) | 141.0 | 0.113 | 0.125 |
| SPPES(40) | 85.7 | 0.625 | 0.014 |
| Nation 112 | 25.4 | 0.036 | 0.069 |
| S-PEEK(1.55)* | 88.9 | 0.364 | 0.024 |
| S-PEEK(1.02)* | 88.9 | 1.710 | 0.005 |

*From Ref [22]

Also listed are the values determined for a Nafion membrane as well as literature values for two sulfonated poly (ether ether ketone) membranes (SPEEK) [22]. The proton conductivity of SPPES(100) was determined to be 0.125 S/cm, which is significantly greater than that of Nafion (0.069 S/cm). However, it is worth noting that the DS/ion exchange capacity of Nafion membrane is considerably smaller than that of SPPES(100). Also, the SPPES membranes were somewhat brittle, thus mechanical stability during fuel cell operation may be an issue. Gautier-Luneau et al. also reported that their Poly(benzylsulfonic acid)siloxane-based membranes reported were also brittle [15].

The proton conductivity of SPPES(40) was determined to be 0.014 S/cm, which is considerably less than that of Nafion but is comparable to that that of SPEEK. While decreasing the DS has decreased the proton conductivity, it has greater improved the mechanical properties. SPPES(40) membranes were much more flexible (less brittle) than SPPES(100) membranes, thus better mechanical stability during fuel cell operation is expected. We are currently investigating the effect of the DS on proton conductivity and mechanical stability as well as copolymerization with other non-sulfonated copolymers that may aid the flexibility of the films.

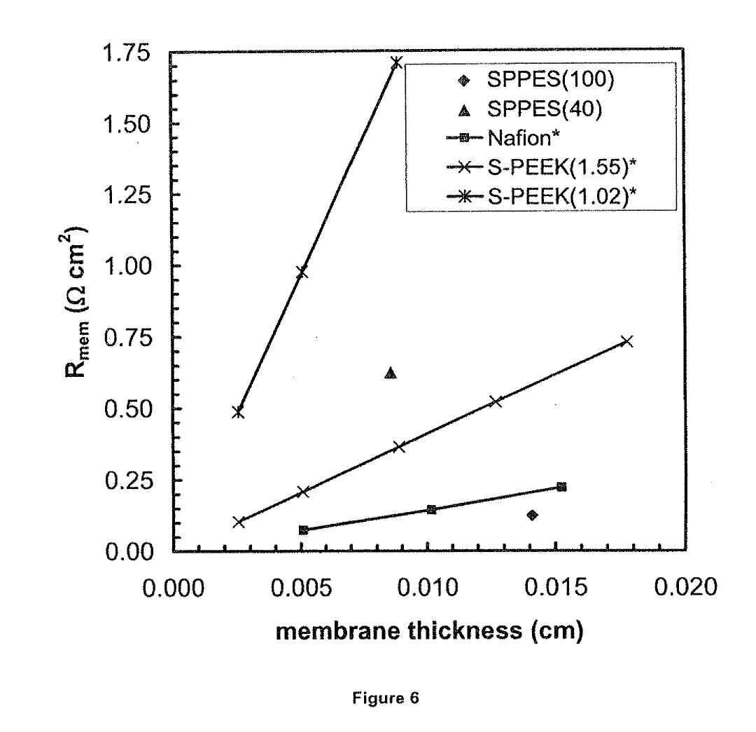

FIG. 6 is a graph of membrane resistances as a function of thickness for SPPES membranes. Also shown are the membrane resistances obtained for Nafion membranes as well as literature data for two SPEEK membranes [22]. Measurements were made at room temperature using fully hydrated membranes.

SPPES membranes have been prepared at two different degrees of sulfonation: 100% and 40%. The former displayed proton conductivity larger than that of Nafion but had poor mechanical properties. Better mechanical properties were achieved by reducing the DS to 40%, thereby forming a SPPES/PPSE. copolymer. While this did reduce the proton conductivity it remained comparable with other PEMs reported in the literature. Thermal analysis indicates SPPES membranes retain more water above 100° C. than Nafion based membranes and may therefore be more suitable for higher temperature fuel cell operation.

To summarize, embodiments of the present invention provide a method of synthesis of sulfonated poly 2-(phenyl ethyl)siloxane membranes. The method involves steps of: a) preparing a mixture comprised of any one of 2-phenylethyl-triethoxysilane, 2-phenylethyl-trimethoxysilane and 2-phenylethyl-trichlorosilane as an organosilanemonomer and anhydrous dichloromethane; b) sulfonating said mixture and stirring for a period of time to ensure substantial completion of the reaction; c) adding a non-sulfonated organosilane monomer to said sulfonated mixture; d) copolymerizing said sulfonated mixture to which said non-sulfonated organosilane monomer has been added by addition of an alcohol, deionized water, and either acid or base to catalyze the reaction, and refluxed for a period of time to ensure substantial completion of the reaction; and e) evaporating solvents and isolating a sulfonated poly 2-(phenyl ethyl)siloxane copolymer membrane.

Step (b) of sulfonating the mixture may be achieved via addition of either ClSO₃H or (CH₃)₃SiSO₃Cl. The alcohol used in step (d) may be methanol, ethanol and any combination thereof. The acid used in step (d) may be HCl. The non-sulfonated organosilane monomer in step (c) may be 2-phenylethyl-triethoxysilane and wherein the membrane is a random copolymer of sulfonated poly 2-(phenyl ethyl)siloxane (SPPES) and poly 2-(phenyl ethyl)siloxane (PPES).

The organosilane monomer in step (a) may be 2-phenylethyl-trimethoxysilane and the non-sulfonated organosilane monomer in step (c) may be a trimethoxysilane derivative and wherein the resulting membrane is a random copolymer of sulfonated poly 2-(phenyl ethyl)siloxane (SPPES) and the non-sulfonated monomer.

The organosilane monomer in step (a) may be 2-phenylethyl-trichlorosilane and the non-sulfonated organosilane monomer in step (c) may be a trichiorosilane derivative and wherein the resulting membrane is a random copolymer of sulfonated poly 2-(phenyl ethyl)siloxane (SPPES) and the non-sulfonated polymer.

The reflux in step (d) may be performed for a minimum of 6 hours. Step (b) may be performed for about 24 hours.

Another embodiment of the invention provides a method of synthesis of sulfonated poly 2-(phenyl ethyl)siloxane membranes which involves the steps of: a) preparing a mixture comprised of any one of 2-(4-chlorosulfonylphenyl)ethyltrimethoxy silane, 2-(4-chlorosulfonylphenyl)ethyltriethoxy silane and 2-(4-chlorosulfonylphenyl)ethyltrichloro silane as a pre-sulfonated organosilane monomer, and anhydrous dichloromethane; b) adding a non-sulfonated organosilane monomer to said sulfonated mixture; c) copolymerizing said sulfonated monomer to which said non-sulfonated organosilane monomer has been added by addition of an alcohol, deionized water, and either acid or base to catalyze the reaction, and refluxed for a period of time to ensure substantial completion of the reaction; and e) evaporating solvents and isolating a sulfonated poly 2-(phenyl ethyl)siloxane copolymer membrane.

The alcohol used in step (c) may be methanol, ethanol and any combination thereof. The acid used in step (c) may be HCl. The reflux in step (c) may be performed for a minimum of 6 hours.

As used herein, the terms “comprises”, “comprising”, “including” and “includes” are to be construed as being inclusive and open ended, and not exclusive. Specifically, when used in this specification including claims, the terms “comprises”, “comprising”, “including” and “includes” and variations thereof mean the specified features, steps or components are included. These terms are not to be interpreted to exclude the presence of other features, steps or components.

The foregoing description of the preferred embodiments of the invention has been presented to illustrate the principles of the invention and not to limit the invention to the particular embodiment illustrated. It is intended that the scope of the invention be defined by all of the embodiments encompassed within the following claims and their equivalents.

### REFERENCES

1. L. Rabinovich and O. LEV, Electroanalysis, 13 (2001) 265-275.
2. O. LEV, Z. Wu, S. Bharathi, V. Glezer, A. Modestov, J. Gun, L. Rabinovich, and S. Sampath, Chem. Mater., 9 (1997) 2354-2375.
3. U. SCHUBERT, N. HUSING, and A. LORENZ, Chem. Mater., 7 (1995) 2010-2027.
4. A. Walcarius, Electroanalysis, 13 (2001) 701-718.
5. A. Walcarius, Chem. Mater., 13 (2001) 3351-3372.
6. C. Sanchez, G. J. D. A. Soler-Illia, F. Ribot, T. Lalot, C. R. Mayer, and V. Cabuil, Chem. Mater., 13 (2001) 3061-3083.
7. V. S. Bagotzky, N. V. Osetrova, and A. M. Skundin, Russian Journal of Electrochemistry, 39 (2003) 919-934.
8. E. B. Easton, Z. G. Qi, A, Kaufman, and P. G. Pickup, Electrochem. Solid-State Lett., 4 (2001) A59-A61.
9. M. L. Anderson, R. M. Stroud, and D. R. Rolison, Nano Letters, 2 (2002) 235-240.
10. N. Miyake, J. S. Wainright, and R. F. Savinell, J. Electrochem. Soc., 148 (2001) A905-A909.
11. N. Miyake, J. S. Wainright, and R. F. Savinell, J. Electrochem. Soc., 148 (2001) A898-A904.
12. B. Baradie, J. P. Dodelet, and D. Guay, J. Electroanal. Chem., 489 (2000) 101-105.
13. K. A. MAURITZ, I. D. STEFANITHIS, S. V. DAVIS, R. W. SCHEETZ, R. K. POPE, G. L. WILKES, and H. H. HUANG, J. Appl. Polym. Sci., 55 (1995) 181-190.
14. P. L. SHAO, K. A. MAURITZ, and R. B. MOORE, Chem. Mater., 7 (1995) 192-200.
15. I. GAUTIERLUNEAU, A. DENOYELLE, J. Y. SANCHEZ, and C. Poinsignon, Electrochim. Acta, 37 (1992) 1615-1618.
16. B. Kumar and J. P. Feliner, J. Power Sources, 123 (2003) 132-136.
17. I. Honma, H. Nakajima, O. Nishikawa, T. Sugimoto, and S. Nomura, J. Electrochem. Soc., 150 (2003) A616-A619.
18. I. Honma, S. Nomura, and H. Nakajima, J, Membr. Sci., 185 (2001) 83-94.
19. H. Nakajima, S. Nomura, T. Sugimoto, S. Nishikawa, and I. Honma, J. Electrochem. Soc., 149 (2002) A953-A959.
20. I. Honma, H. Nakajima, O. Nishikawa, T. Sugimoto, and S. Nomura, J. Electrochem. Soc., 149 (2002) A1389-A1392.
21. J. I. Eastcott and E. B. Easton, Electrochim. Acta, to be submitted (2008).
22. E. B. Easton, T. D. Astill, and S. Holdcroft, J. Electrochem. Soc., 152 (2005) 752-758.
23. C. Chuy, J. F. Ding, E. Swanson, S. Holdcroft, J. Horsfall, and K. V. Lovell, J. Electrochem. Soc., 150 (2003) E271-E279.

1. A polymer electrolyte membrane based on a sulfonated poly 2-(phenyl ethyl)siloxane (SPPES) and a non-sulfonated organosilane precursor, as depicted by: 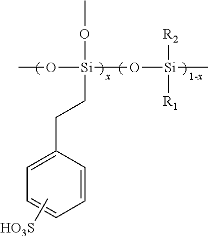
wherein 0≦X≦1 and X represents the relative proportion of SPPES, which is the degree of sulfonation, wherein R₁ and R₂ are substituent groups on said non-sulfonated organosilane precursor.

2. The polymer electrolyte membrane according to claim 1, wherein X is less than 1, and the membrane is based on random copolymers of said sulfonated poly 2-(phenyl ethyl)siloxane (SPPES) and said non-sulfonated organosilane precursor.

3. The polymer electrolyte membrane according to claim 2 wherein said non-sulfonated organosilane precursor is one of the following compounds:

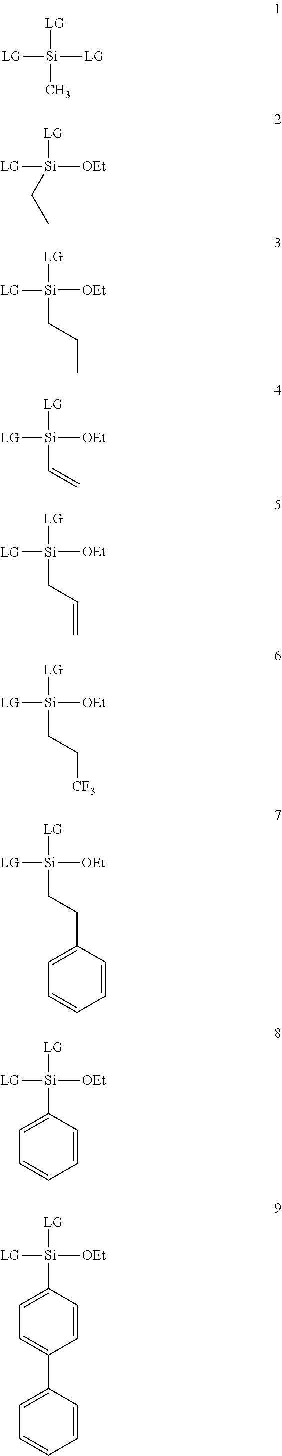

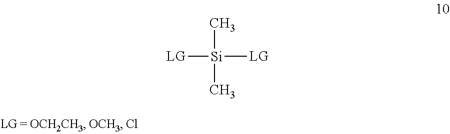

4. The polymer electrolyte membrane according to claim 2 wherein said non-sulfonated organosilane precursor is 2-phenylethyl-triethoxysilane and wherein said random copolymers are sulfonated poly 2-(phenyl ethyl)siloxane (SPPES)/poly 2-(phenyl ethyl)siloxane (PPES).

5. The polymer electrolyte membrane according to claim 1 wherein X=1 and said polymer is a homopolymer of sulfonated poly 2-(phenyl ethyl)siloxane (SPPES), as depicted by:

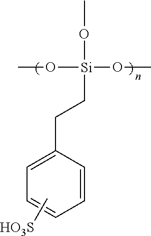

6. A method of synthesis of sulfonated poly 2-(phenyl ethyl)siloxane membranes comprising the steps of:
a) preparing a mixture comprised of any one of 2-phenylethyl-triethoxysilane, 2-phenylethyl-trimethoxysilane and 2-phenylethyl-trichlorosilane as an organosilanemonomer and anhydrous dichloromethane;
b) sulfonating said mixture and stirring for a period of time to ensure substantial completion of the reaction;
c) adding a non-sulfonated organosilane monomer to said sulfonated mixture;
d) copolymerizing said sulfonated mixture to which said non-sulfonated organosilane monomer has been added by addition of an alcohol, deionized water, and either acid or base to catalyze the reaction, and refluxed for a period of time to ensure substantial completion of the reaction; and
e) evaporating solvents and isolating a sulfonated poly 2-(phenyl ethyl)siloxane copolymer membrane.

7. The method of membrane synthesis of claim 6 wherein step (b) of sulfonating said mixture is achieved via addition of either ClSO₃H or (CH₃)₃SiSO₃Cl.

8. The method of membrane synthesis of claim 6 wherein step (b) of sulfonating said mixture is achieved via addition of ClSO₃H.

9. The method of membrane synthesis of claim 6, wherein said alcohol used in step (d) is one of methanol and ethanol.

10. The method of membrane synthesis of claim 6, wherein said alcohol used in step (d) is methanol.

11. The method of membrane synthesis of claim 6, wherein said acid used in step (d) is HCl.

12. A method of membrane synthesis of claim 6, wherein said non-sulfonated organosilane monomer in step (c) is 2-phenylethyl-triethoxysilane and wherein said membrane is a random copolymer of sulfonated poly 2-(phenyl ethyl)siloxane (SPPES) and poly 2-(phenyl ethyl)siloxane (PPES).

13. A method of membrane synthesis of claim 6, wherein said organosilane monomer in step (a) is 2-phenylethyl-trimethoxysilane and said non-sulfonated organosilane monomer in step (c) is a trimethoxysilane derivative and wherein said membrane is a random copolymer of sulfonated poly 2-(phenyl ethyl)siloxane (SPPES) and the non-sulfonated monomer.

14. A method of membrane synthesis of claim 6, wherein said organosilane monomer in step (a) is 2-phenylethyl-trichlorosilane and said non-sulfonated organosilane monomer in step (c) is a trichlorosilane derivative and wherein said membrane is a random copolymer of sulfonated poly 2-(phenyl ethyl)siloxane (SPPES) and the non-sulfonated polymer.

15. A method of membrane synthesis of claim 6, wherein said reflux in step (d) is performed for a minimum of 6 hours.

16. A method of membrane synthesis of claim 6 wherein step (b) is performed for about 24 hours.

17. A method of synthesis of sulfonated poly 2-(phenyl ethyl)siloxane membranes comprising the steps of:
a) preparing a mixture comprised of any one of 2-(4-chlorosulfonylphenyl)ethyltrimethoxy silane, 2-(4-chlorosulfonylphenyl)ethyltriethoxy silane and 2-(4-chlorosulfonylphenyl)ethyltrichloro silane as a pre-sulfonated organosilane monomer, and anhydrous dichloromethane;
b) adding a non-sulfonated organosilane monomer to said sulfonated mixture;
c) copolymerizing said sulfonated monomer to which said non-sulfonated organosilane monomer has been added by addition of an alcohol, deionized water, and either acid or base to catalyze the reaction, and refluxed for a period of time to ensure substantial completion of the reaction; and
d) evaporating solvents and isolating a sulfonated poly 2-(phenyl ethyl)siloxane copolymer membrane.

18. The method of membrane synthesis of claim 17 wherein said alcohol used in step (c) is one of methanol and ethanol.

19. The method of membrane synthesis of claim 17 wherein said alcohol used in step (c) is methanol.

20. The method of membrane synthesis of claim 17, wherein said acid used in step (c) is HCl.

21. A method of membrane synthesis of claim 17 wherein said reflux in step (c) is performed for a minimum of 6 hours.
